(19) United States
(12) Patent Application Publication
(10) Pub. No.: US 2017/0336275 A1
(43) Pub. Date: Nov. 23, 2017

(54) Pressure Transducer

(71) Applicants: Kai Wang, Shenzhen (CN); Hu Chen, Shenzhen (CN); Guojun Liu, Shenzhen (CN)

(72) Inventors: Kai Wang, Shenzhen (CN); Hu Chen, Shenzhen (CN); Guojun Liu, Shenzhen (CN)

(73) Assignee: AAC Technologies Pte. Ltd., Singapore city (SG)

(21) Appl. No.: 15/416,721

(22) Filed: Jan. 26, 2017

(30) Foreign Application Priority Data
May 17, 2016 (CN) 201620448964.7

(51) Int. Cl. G01L 1/26; G01K 13/00

(52) U.S. Cl. CPC G01L 1/26; G01K 13/00

(57) ABSTRACT

A pressure transducer is disclosed. The pressure transducer includes an encapsulation structure provided with an accommodation space; a MEMS chip for detecting pressure signal accommodated in the accommodation space; an ASIC chip received in the accommodation space. The ASIC chip includes a signal processing module connected to MEMS chip for processing the pressure signal detected by the MEMS chip and outputting the processed pressure signal. The pressure transducer further includes a temperature detection module for detecting temperature signal and outputting the temperature signal.

### FIELD OF THE INVENTION

The present invention relates to a pressure transducer, especially to a kind of pressure transducer with temperature detection function.

### DESCRIPTION OF RELATED ART

The existing pressure transducer has pressure detection function, but the existing pressure transducer can't detect the ambient temperature around the pressure transducer.

Therefore, it is necessary to provide a kind of new technology solution to overcome above disadvantage.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of a pressure transducer in accordance with an exemplary embodiment of the present disclosure.

FIG. 2 is an illustrative module diagram of the pressure transducer in FIG. 1.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

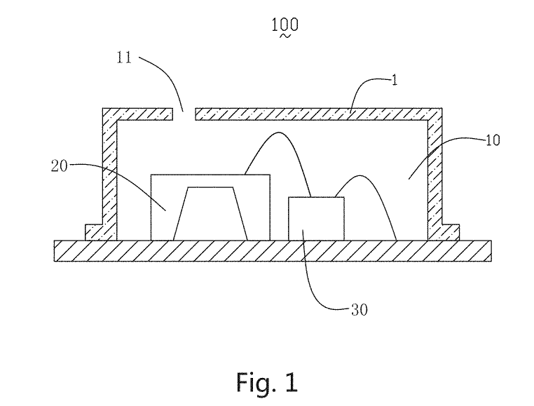

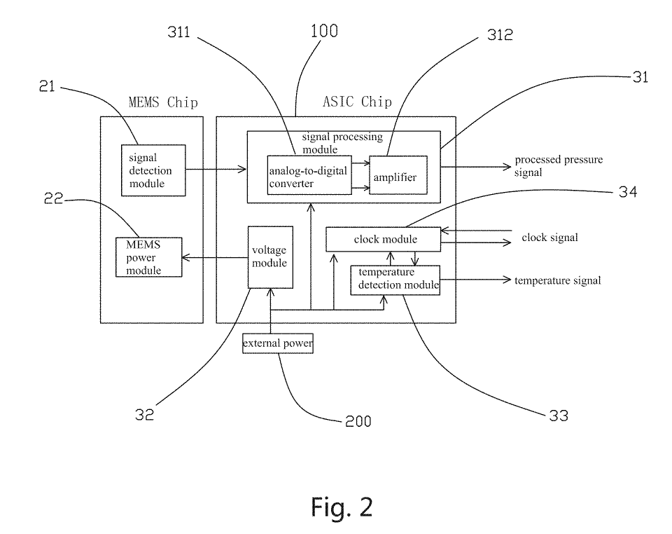

Referring to FIGS. 1-2, a pressure transducer 100, in accordance with an exemplary embodiment of the present disclosure, is connected to an external power 200. The pressure transducer 100 comprises an encapsulation structure 1 with an accommodation space 10, a MEMS chip 20 and an ASIC chip 30 with several circuit modules set in the accommodation space, and an air hole 11 set in the encapsulation structure 1. The air hole 11 can be set above or under the encapsulation structure 1.

The MEMS chip 20 includes a signal detection module 21 and a MEMS power module 22, and the signal detection module 21 is used for detecting pressure signal, and the pressure signal is differential analog signal. The signal detection module 21 transits the differential analog signal to the ASIC chip 30.

The circuit module on the ASIC chip 30 includes a signal processing module 31 connected to the signal detection module 21 on the MEMS chip 20, a voltage module 32 that provides drive voltage for the MEMS power module 22 on the MEMS chip 20, a temperature detection module 32 that is used for detecting ambient temperature and outputting the ambient temperature and a clock module 34 connected to the temperature detection module 33. The signal processing module 31 includes an analog-to-digital converter 311 that converts the analog signal to digital signal and an amplifier 312 that amplifies the digital signal, and the voltage module 32 provides the constant voltage that drives the MEMS power module, and the clock module 34 controls whether the temperature detection module 33 outputs temperature signal or not. The temperature detection module 33 is digital circuit module, by which the signal output is digital signal.

The external power 200 is connected to the signal processing module 31, the power module 32, the temperature detection module 33 and the clock module 34 on the ASIC chip 30 respectively, in order to drive each of above described circuit module.

Specifically, while pressure signal is detected, the signal detection module 21 on the MEMS chip 20 transits the analog signal to the signal processing module 311, the analog-to-digital converter 311 on the signal processing module 311 converts the differential analog signal received into digital signal, and the amplifier 312 amplifies the above digital signal. The signal processing module 31 then outputs useful electric signal finally, i.e. pressure signal that has been processed, meanwhile, the temperature detection module 33 detects temperature signal according to the current working environment, and transmits the signal to the clock module 34. The clock module 34 receives the external clock signal, and then the clock module 34 outputs the control signal to the temperature detection module 33. The temperature detection module 33 determines whether to output temperature signal or not based on the control signal, and the clock signal can be digital signal in various modes.

The temperature detection module is applied in the pressure transducer, which makes the pressure transducer detect its working ambient temperature in real time.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A pressure transducer, comprising:
an encapsulation structure provided with an accommodation space;
a MEMS chip for detecting pressure signal accommodated in the accommodation space;
an ASIC chip received in the accommodation space, the ASIC chip including a signal processing module connected to MEMS chip for processing the pressure signal detected by the MEMS chip and outputting the processed pressure signal; wherein
the pressure transducer further includes a temperature detection module for detecting temperature signal and outputting the temperature signal.

2. The pressure transducer as described in claim 1, wherein the temperature detection module is a digital circuit module.

3. The pressure transducer as described in claim 1, wherein, the ASIC chip further includes a clock module connected to the temperature detection module, and the clock module controls whether the temperature detection module outputs temperature signal or not.

4. The pressure transducer as described in claim 1, wherein the MEMS chip includes a signal detection module for transmitting the pressure signal to the signal processing module.

5. The pressure transducer as described in claim 4, wherein the pressure signal detected by the signal detection module is a differential analog signal.

6. The pressure transducer as described in claim 5, wherein the signal processing module further includes an analog-to-digital converter that converts the differential analog signal to digital signal.

7. The pressure transducer as described in claim 6, wherein the signal processing module further includes an amplifier that amplifies the digital signal.

8. The pressure transducer as described in claim 1, wherein the MEMS chip includes a MEMS power module, and the ASIC chip includes a voltage module for providing drive voltage to the MEMS power module.
